(19) United States
(12) Patent Application Publication
(10) Pub. No.: US 2023/0415310 A1
(43) Pub. Date: Dec. 28, 2023

(54) Driver Device

(71) Applicant: Ignacio Quintana, Lake Elsinore, CA (US)

(72) Inventor: Ignacio Quintana, Lake Elsinore, CA (US)

(21) Appl. No.: 18/338,922

(22) Filed: Jun. 21, 2023

Related U.S. Application Data
(60) Provisional application No. 63/355,120, filed on Jun. 24, 2022.

(51) Int. Cl. B25B 21/00

(52) U.S. Cl. CPC B25B 21/002

(57) ABSTRACT

A driver device is disclosed that is a specialized tool for driving threaded nuts onto threaded rods. The driver device comprises a body component that is cylindrical in shape with a blind cavity or hole at one end. The opposing end is rounded with tapered or chamfered edges to contact the side of the threaded nut during rotation. The blind cavity is configured to accept the square connector end of a conventional driver bit. Once in position on the driver bit, the bit is then secured within a conventional drill chuck. The drill of the drill chuck can then act to thread the nut onto the threaded rod via the rotational spin created by the drill.

### CROSS-REFERENCE TO RELATED APPLICATION

The present application claims priority to, and the benefit of, U.S. Provisional Application No. 63/355,120, which was filed on Jun. 24, 2022, and is incorporated herein by reference in its entirety.

### FIELD OF THE INVENTION

The present invention relates generally to the field of driver devices. More specifically, the present invention relates to a removable rubber attachment that secures to any cordless drill chuck, making the threaded nut installation process quicker and easier. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in driver devices. Generally, threading nuts onto threading rods can be a difficult and frustrating process. Typically, nuts are spun onto threads by hand, usually with one's fingers. The main problem with conventional nut installation is that the process is very inefficient, requiring substantial time to install and turn the nut by hand. Often, a worker is placed in an awkward, difficult, and poor ergonomic position to install and turn a nut on a threaded shaft. Another problem with conventional nut installation is that the uncomfortable and repetitive motion of the worker's hands may cause injury to the worker over time. Further, users can develop blisters on their hands, while trying to complete the process manually. Thus, significant time and effort can be wasted trying to thread nuts onto threading rods.

As can be seen, there is a need for a tool to reduce the time and work involved in installing and turning a nut on a threaded shaft. More particularly, there is a demand for a driver device that makes nut installation quicker and easier, even when encountering bad threads on the threaded rod.

Therefore, there exists a long-felt need in the art for a driver device that provides a removable rubber attachment which attaches to any cordless drill chuck, making the nut installation process quicker and easier. There is also a long-felt need in the art for a driver device that reduces the amount of time it takes to manually thread a nut onto a threaded rod. Further, there is a long-felt need in the art for a driver device that can be used by people of all trades to construct supports, such as construction workers, HVAC workers, plumbers, electricians, and maintenance workers. Moreover, there is a long-felt need in the art for a device that provides a specialized tool for driving nuts onto threaded rods. Further, there is a long-felt need in the art for a driver device that utilizes a cordless drill to thread the nut onto the threaded rod. Finally, there is a long-felt need in the art for a driver device that can be utilized even when bad threads are encountered on the threaded rod.

The subject matter disclosed and claimed herein, in one embodiment thereof, comprises a driver device. The device is a specialized tool for driving threaded nuts onto threaded rods. The driver device comprises a body component that is cylindrical in shape with a blind cavity or hole at one end. The opposing end is rounded with tapered or chamfered edges to contact the side of the threaded nut during rotation. The blind cavity is configured to accept the square connector end of a conventional driver bit. Once in position on the driver bit, the bit is then secured within a conventional drill chuck. The drill of the drill chuck can then act to thread the nut onto the threaded rod via the rotational spin created by the drill.

In use, the driver device is positioned in contact with the side of the threaded nut, which is threaded onto the top of the threaded rod. Once the device is in place, the drill is engaged, and the threaded nut is rotated onto the threaded rod with ease. Further, the driver device will not cause damage to itself, even when encountering bad or fouled threads on the threaded rod. In use, the driver device will clutch, or power through, the encountered fouled threads on the threaded rod with ease.

In this manner, the driver device of the present invention accomplishes all of the foregoing objectives and provides users with a device that is safe to use and easy to install on a conventional drill. The device is a cylindrical structure that engages a threaded nut. The device can be manufactured of rubber material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a driver device. The device is a specialized tool for driving threaded nuts onto threaded rods. The driver device comprises a body component that is cylindrical in shape with a blind cavity or hole at one end. The opposing end is rounded with tapered or chamfered edges to contact the side of the threaded nut during rotation. The blind cavity is configured to accept the square connector end of a conventional driver bit. Once in position on the driver bit, the bit is then secured within a conventional drill chuck. The drill of the drill chuck can then act to thread the nut onto the threaded rod via the rotational spin created by the drill.

Generally, the present invention provides a driver device that is configured to install nuts onto threaded shafts or rods, such as all-thread rods and bolts. The driver device may be driven by a power drill which causes the driver device to rotate. The driver device contacts a nut, thereby causing the nut to rotate. The driver device may be manufactured of an elastomeric polymer for gripping the nut during use. Thus, a user may install and spin a nut on a threaded shaft without requiring their fingers to manually rotate the nut. Accordingly, the driver device may drastically reduce the time required to install nuts onto threaded rods.

In one embodiment, the driver device comprises a body component. The body component can be any suitable shape and size as is known in the art, but preferably the body component is cylindrical in shape. Generally, the body component comprises a length suitable for allowing the device to fit onto a conventional driver bit. The body component comprises opposing ends and a cylindrical center section. The first end of the body component comprises a blind cavity or hole. The blind cavity can be any suitable shape and size as is known in the art, as long as the blind cavity is shaped and sized to accept a conventional driver bit. Typically, the blind cavity is shaped as a circular hole or a square hole that tapers in but can be any suitable shape. Specifically, the blind cavity is shaped and sized to accept the square connector end (or socket attachment) of a conventional driver bit.

Accordingly, the blind cavity may have a cross-sectional shape that may fit into the square connector end. In some embodiments, the cross-sectional shape of the blind cavity may be hexagonal, which may permit the blind cavity to fit into many conventional driver bits. Thus, the blind cavity may have, for example, a ¼ or ⅜ inch hexagonal cross-section. In other embodiments, the cross-sectional shape of the blind cavity may be circular or square with tapers that allow the blind cavity to engage with and secure to the square connector end of a driver bit. Accordingly, the driver device is easy to install and remove as the device can be inserted onto the square connector end via the blind cavity for use and pulled off when not in use. Typically, the driver device does not require fasteners or other securing means and is merely inserted onto the square connector end and secured via friction fit. However, in one embodiment, the driver device can be secured to the square connector end via a fastener, such as adhesives, glue, etc. The removable attachment of the device with the driver bit permits replacement of the device, either when the device is worn, or to change the size or shape of the device.

In one embodiment, once the driver device is in place on the square connector end, the opposing end of the driver bit, the chuck end is inserted into the chuck of a conventional drill. Once secured onto the drill, the drill is engaged in a conventional means which causes the driver device to rotate. The drill of the drill chuck can then act to thread the nut onto the threaded rod via the rotational spin created by the drill.

In one embodiment, the second end of the body component is rounded with tapered or chamfered edges to contact the side of the threaded nut during rotation. This shape may allow turning of the nut regardless of the angle of contact between the second end of the body component and the nut. The rounded end may allow a user to install the nut completely threaded or nearly completely threaded on the threaded rod. Therefore, little or no manual threading of the nut on the threaded rod may be required. In another embodiment, the rounded end may have an outer layer adapted to grip the nut, wherein rotation of the outer layer may cause the nut to rotate on a threaded rod. The outer layer may be a resilient material formed from, for example, rubber, such as neoprene, silicone, or the like. The outer layer may comprise ridges or gripping sections that engage the nut and make it easier for the drill to rotate the nut on the threaded rod. In some embodiments, the cylindrical center section may also comprise ridges or gripping sections that engage the nut.

In one embodiment, the second end can be configured in various shapes and sizes, depending on the needs and/or wants of a user, The different configurations of the second end may be used for turning the nut. For example, a second end that is wider may be used in close fitting situations or for larger nuts. A needle or narrower shaped second end may be used to reach nuts where there is minimal clearance between the nut and its surroundings.

In use, the driver device is rotated with a conventional drill. The drill can be a cordless or corded drill, as is known in the art. The second end of the device may contact the nut, rotating the nut on the threaded rod. By keeping constant contact between the nut and the second end of the device, the nut can be turned on the threaded rod. The user can increase or decrease the speed of the drill, and thus, increase or decrease the speed of the nut's rotation. The angle of contact between the second end of the device and the nut may be varied while still achieving rotation of the nut. The driver device may be used to turn various size nuts, from small nuts (i.e., #6, #8, etc.) to larger nuts (i.e., ½″, ¾″, etc.).

Typically, the driver device is positioned such that the second end is in contact with the side of the threaded nut, which is threaded onto the top of the threaded rod. Once the device is in place, the drill is engaged, and the threaded nut is rotated onto the threaded rod with ease. Further, the driver device will not cause damage to itself or to the threaded nut, even when encountering bad or fouled threads on the threaded rod. In use, the driver device will clutch or power the threaded nut through the encountered fouled threads on the threaded rod with ease.

In one embodiment, the driver device is manufactured of a rubber material or any other suitable elastomeric polymer as is known in the art. Specifically, the driver device is formed of a material capable of rotating a nut on a threaded shaft or rod when the driver device is rotated while contacting the nut.

In yet another embodiment, the driver device comprises a plurality of indicia.

In yet another embodiment, a method of threading a threaded nut onto a threaded rod with ease is disclosed. The method includes the steps of providing a driver device comprising a body component that is cylindrical in shape with a blind cavity at one end and a rounded opposing end with chamfered edges. The method also comprises inserting the blind cavity onto the square connector end of a driver bit. Further, the method comprises securing the driver bit into the chuck of a cordless drill. The method comprises positioning the rounded end of the device in contact with a side of the threaded nut. Finally, the method comprises engaging the drill which rotates the device and threads the nut onto the threaded rod.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the driver device of the present invention showing the device applied to a conventional square connector end of a driver bit in accordance with the disclosed architecture;

FIG. 2 illustrates a perspective view of one embodiment of the driver device of the present invention showing the device disengaged from the square connector end in accordance with the disclosed architecture;

FIG. 3 illustrates a perspective view of one embodiment of the driver device of the present invention showing the blind cavity end of the device in accordance with the disclosed architecture;

FIG. 4 illustrates a perspective view of one embodiment of the driver device of the present invention showing the rounded, chamfered end of the device in accordance with the disclosed architecture;

FIG. 5 illustrates a perspective view of one embodiment of the driver device of the present invention showing the device secured on a conventional driver bit in accordance with the disclosed architecture; and

FIG. 6 illustrates a flowchart showing the method of threading a threaded nut onto a threaded rod with ease in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a driver device that provides a removable rubber attachment which attaches to any cordless drill chuck making the nut installation process quicker and easier. There is also a long-felt need in the art for a driver device that reduces the amount of time it takes to manually thread a nut onto a threaded rod. Further, there is a long-felt need in the art for a driver device that can be used by people of all trades to construct supports, such as construction workers, HVAC workers, plumbers, electricians, and maintenance workers. Moreover, there is a long-felt need in the art for a device that provides a specialized tool for driving nuts onto threaded rods. Further, there is a long-felt need in the art for a driver device that utilizes a cordless drill to thread the nut onto the threaded rod. Finally, there is a long-felt need in the art for a driver device that can be utilized even when bad threads are encountered on the threaded rod.

The present invention, in one exemplary embodiment, is a novel driver device. The device is a specialized tool for driving threaded nuts onto threaded rods. The driver device comprises a body component that is cylindrical in shape with a blind cavity or hole at one end. The opposing end is rounded with tapered or chamfered edges to contact the side of the threaded nut during rotation. The blind cavity is configured to accept the square connector end of a conventional driver bit. Once in position on the driver bit, the bit is then secured within a conventional drill chuck. The drill of the drill chuck can then act to thread the nut onto the threaded rod via the rotational spin created by the drill. The present invention also includes a novel method of threading a threaded nut onto a threaded rod with ease. The method includes the steps of providing a driver device comprising a body component that is cylindrical in shape with a blind cavity at one end and a rounded opposing end with chamfered edges. The method also comprises inserting the blind cavity onto the square connector end of a driver bit. Further, the method comprises securing the driver bit into the chuck of a cordless drill. The method comprises positioning the rounded end of the device in contact with a side of the threaded nut. Finally, the method comprises engaging the drill which rotates the device and threads the nut onto the threaded rod.

Referring initially to the drawings, FIG. 1 illustrates a perspective view of one embodiment of the driver device 100 of the present invention. In the present embodiment, the driver device 100 is an improved driver device 100 that provides a user with a removable rubber attachment that attaches to a conventional drill 112 for threading a nut 114 onto a threaded rod 116 with ease. The device 100 is a specialized tool for driving threaded nuts 114 onto threaded rods 116. Specifically, the driver device 100 comprises a body component 102 with a blind cavity 104 at a first end 106 and a rounded opposing second end 108 with chamfered edges 110 to contact the side 118 of the threaded nut 114 during rotation. The blind cavity 104 is configured to accept the connector end 120 of a conventional driver bit 122. Once in position on the driver bit 122, the bit 122 is then secured within a conventional drill chuck 124. The drill 112 of the drill chuck 124 can then act to thread the nut 114 onto the threaded rod 116 via the rotational spin created by the drill 112.

Generally, the present invention provides a driver device 100 that is configured to install nuts 114 onto threaded shafts or rods 116, such as all-thread rods and bolts. The driver device 100 may be driven by a power drill 112 which causes the driver device 100 to rotate. The driver device 100 contacts a nut 114, thereby causing the nut 114 to rotate. The driver device 100 may be manufactured of an elastomeric polymer for gripping the nut 114 during use. Thus, a user may install and spin a nut 114 on a threaded shaft 116 without requiring their fingers to manually rotate the nut 114. Accordingly, the driver device 100 may drastically reduce the time required to install nuts 114 onto threaded rods 116.

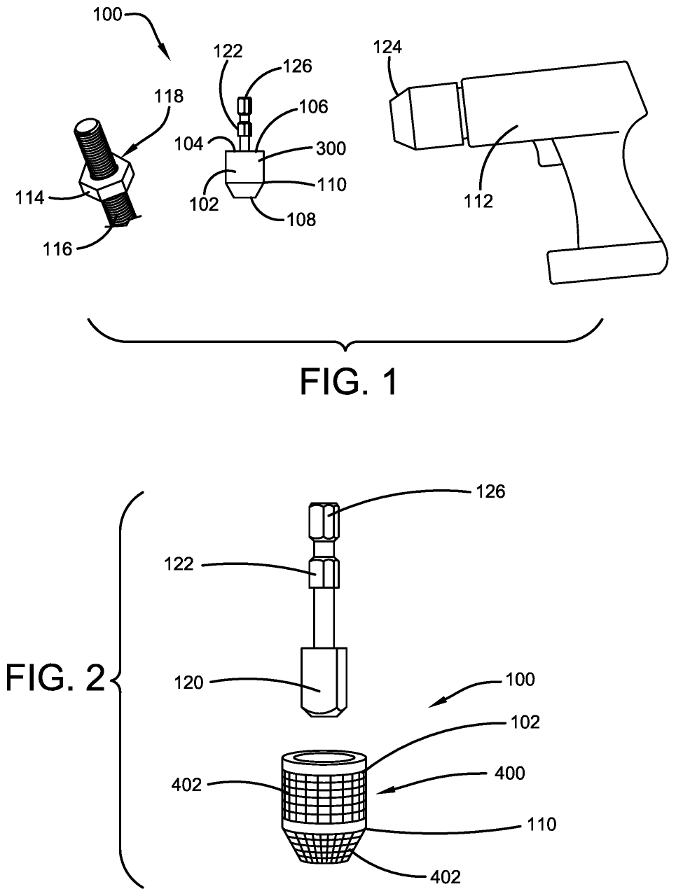

As shown in FIGS. 1-2, once the driver device 100 is in place on the square connector end 120, the opposing end of the driver bit 122, the chuck end 126 is inserted into the chuck 124 of a conventional drill 112. Once secured onto the drill 112, the drill 112 is engaged in a conventional means which causes the driver device 100 to rotate. The drill 112 of the drill chuck 124 can then act to thread the nut 114 onto the threaded rod 116 via the rotational spin created by the drill 112. Thus, a user does not have to manually thread the nut 114 onto the threaded rod 116 by hand, saving both time and energy.

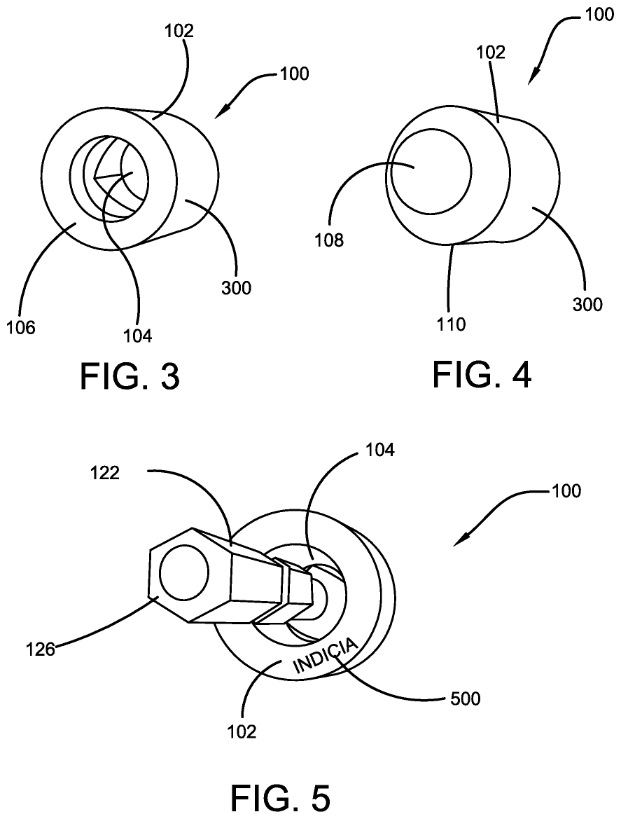

As shown in FIG. 3, the driver device 100 comprises a body component 102. The body component 102 can be any suitable shape and size as is known in the art, but preferably the body component 102 is cylindrical in shape. Generally, the body component 102 comprises a length suitable for allowing the device 100 to fit onto a conventional driver bit 122. The body component 102 comprises opposing ends and a cylindrical center section 300. The first end 106 of the body component 102 comprises a blind cavity 104 or hole. The blind cavity 104 can be any suitable shape and size as is known in the art, as long as the blind cavity 104 is shaped and sized to accept a conventional driver bit 122. Typically, the blind cavity 104 is shaped as a circular hole or a square hole that tapers in but can be any suitable shape. Specifically, the blind cavity 104 is shaped and sized to accept the square connector end 120 (or socket attachment) of a conventional driver bit 122.

Accordingly, the blind cavity 104 may have a cross-sectional shape that may fit into the square connector end 120. In some embodiments, the cross-sectional shape of the blind cavity 104 may be hexagonal, which may permit the blind cavity 104 to fit into many conventional driver bits 122. Thus, the blind cavity 104 may have, for example, a ¼ inch hexagonal cross-section. In other embodiments, the cross-sectional shape of the blind cavity 104 may be circular or square with tapers that allow the blind cavity 104 to engage with, and secure to the square connector end 120 of a driver bit 122. Accordingly, the driver device 100 is easy to install and remove as the device 100 can be inserted onto the square connector end 120 via the blind cavity 104 for use and pulled off when not in use. Typically, the driver device 100 does not require fasteners or other securing means and is merely inserted onto the square connector end 120 and secured via friction fit. However, in one embodiment, the driver device 100 can be secured to the square connector end 120 via a fastener, such as adhesives, glue, etc. The removable attachment of the device 100 with the driver bit 122 permits replacement of the device 100, either when the device 100 is worn, or to change the size or shape of the device 100.

As shown in FIG. 4, the second end 108 of the body component 102 is rounded with tapered or chamfered edges 110 to contact the side 118 of the threaded nut 114 during rotation. This shape may allow turning of the nut 114 regardless of the angle of contact between the second end 108 of the body component 102 and the nut 114. The rounded end 108 may allow a user to install the nut 114 completely threaded or nearly completely threaded on the threaded rod 116. Therefore, little or no manual threading of the nut 114 on the threaded rod 116 may be required. In another embodiment, the rounded end 108 may have an outer layer 400 adapted to grip the nut 114, wherein rotation of the outer layer 400 may cause the nut 114 to rotate on a threaded rod 116. The outer layer 400 may be a resilient material formed from, for example, rubber, such as neoprene, silicone, or the like. The outer layer 400 may comprise ridges or gripping sections 402 that engage the nut 114 and make it easier for the drill 112 to rotate the nut 114 on the threaded rod 116. In some embodiments, the cylindrical center section 300 may also comprise ridges or gripping sections 402 that engage the nut 114.

Further, the second end 108 can be configured in various shapes and sizes, depending on the needs and/or wants of a user, The different configurations of the second end 108 may be used for turning the nut 114. For example, a second end 108 that is wider may be used in close fitting situations or for larger nuts 114. A needle or narrower shaped second end may be used to reach nuts 114 where there is minimal clearance between the nut 114 and its surroundings.

As shown in FIG. 5, in use, the driver device 100 is rotated with a conventional drill 112. The drill 112 can be a cordless or corded drill, as is known in the art. The second end 108 of the device 100 may contact the nut 114, rotating the nut 114 on the threaded rod 116. By keeping constant contact between the nut 114 and the second end 108 of the device 100, the nut 114 can be turned on the threaded rod 116. The user can increase or decrease the speed of the drill 112, and thus, increase or decrease the speed of the nut's rotation. The angle of contact between the second end 108 of the device 100 and the nut 114 may be varied while still achieving rotation of the nut 114. The driver device 100 may be used to turn various size nuts 114, from small nuts (i.e., #6, #8, etc.) to larger nuts (i.e., ½″, ¾″, etc.).

Typically, the driver device 100 is positioned such that the second end 108 is in contact with the side 118 of the threaded nut 114, which is threaded onto the top of the threaded rod 116. Once the device 100 is in place, the drill 112 is engaged and the threaded nut 114 is rotated onto the threaded rod 116 with ease. Further, the driver device 100 will not cause damage to itself or to the threaded nut 114, even when encountering bad or fouled threads on the threaded rod 116. In use, the driver device 100 will clutch or power the threaded nut 114 through the encountered fouled threads on the threaded rod 116 with ease.

In one embodiment, the driver device 100 is manufactured of a rubber material or any other suitable elastomeric polymer as is known in the art. Specifically, the driver device 100 is formed of a material capable of rotating a nut 114 on a threaded shaft or rod 116 when the driver device 100 is rotated while contacting the nut 114.

In yet another embodiment, the driver device 100 comprises a plurality of indicia 500. The body component 102 of the device 100 may include advertising, trademark, other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be driver, nut, or brand related.

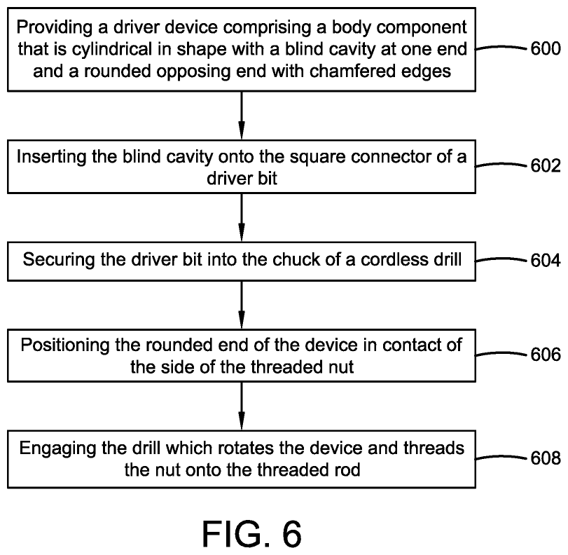

FIG. 6 illustrates a flowchart of the method of threading a threaded nut onto a threaded rod with ease. The method includes the steps of at 600, providing a driver device comprising a body component that is cylindrical in shape with a blind cavity at one end and a rounded opposing end with chamfered edges. The method also comprises at 602, inserting the blind cavity onto the square connector end of a driver bit. Further, the method comprises at 604, securing the driver bit into the chuck of a cordless drill. The method comprises at 606, positioning the rounded end of the device in contact with a side of the threaded nut. Finally, the method comprises at 608, engaging the drill which rotates the device and threads the nut onto the threaded rod.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “driver device” and “device” are interchangeable and refer to the driver device 100 of the present invention.

Notwithstanding the foregoing, the driver device 100 of the present invention can be of any suitable size and configuration as is known in the art without affecting the overall concept of the invention, provided that it accomplishes the above-stated objectives. One of ordinary skill in the art will appreciate that the driver device 100 as shown in FIGS. 1-6 are for illustrative purposes only, and that many other sizes and shapes of the driver device 100 are well within the scope of the present disclosure. Although the dimensions of the driver device 100 are important design parameters for user convenience, the driver device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A driver device that provides a user with a removable rubber attachment for threading a nut onto a threaded rod, the driver device comprising:
a body component with a blind cavity at one end;
wherein the blind cavity accepts a driver bit;
wherein the driver bit is secured within a drill;
wherein the body component is positioned in contact with a nut; and
further wherein the drill is engaged which acts to thread the nut onto a threaded rod via rotational spin created by the drill.

2. The driver device of claim 1, wherein the drill is a corded or cordless drill.

3. The driver device of claim 1, wherein the body component comprises opposing ends and a cylindrical center section.

4. The driver device of claim 3, wherein the opposing ends comprise a first end and a second end.

5. The driver device of claim 4, wherein the first end comprises the blind cavity.

6. The driver device of claim 5, wherein the blind cavity is shaped as a circular hole or a square hole that tapers in to accept a square connector end of the driver bit.

7. The driver device of claim 6, wherein the second end of the body component is rounded with chamfered edges to contact a side of the nut during rotation.

8. The driver device of claim 7, wherein the second end comprises an outer layer adapted to grip the nut.

9. The driver device of claim 8, wherein the outer layer is made of rubber, such as neoprene or silicone.

10. The driver device of claim 9, wherein the outer layer comprises gripping sections that engage the nut and make it easier for the drill to rotate the nut on the threaded rod.

11. The driver device of claim 10, wherein the cylindrical center section comprises gripping sections that engage the nut.

12. The driver device of claim 11, wherein once the driver device is in place on the square connector end, a chuck end of the driver bit is inserted into a drill chuck of the drill.

13. The driver device of claim 12, wherein once the driver device is positioned on the drill, the driver device is positioned such that the second end is in contact with a side of the nut, which is threaded onto a top of the threaded rod, the drill is engaged and the nut is rotated onto the threaded rod with ease.

14. A driver device that provides a user with a removable rubber attachment for threading a nut onto a threaded rod, the driver device comprising:
a body component comprising a first end and a second end and a cylindrical center section;
wherein the first end comprises the blind cavity, which is shaped as a circular hole or a square hole that tapers in to accept a square connector end of a driver bit;
wherein the second end of the body component is rounded with chamfered edges to contact a side of a nut during rotation;
wherein once the driver device is in place on the square connector end, a chuck end of the driver bit is inserted into a drill chuck of a drill;
wherein once the driver device is positioned on the drill, the driver device is positioned such that the second end is in contact with a side of the nut, which is threaded onto a top of the threaded rod; and
further wherein the drill is engaged, and the nut is rotated onto the threaded rod with ease via rotational spin created by the drill.

15. The driver device of claim 14 further comprising a plurality of indicia.

16. The driver device of claim 14, wherein the second end comprises an outer layer adapted to grip the nut.

17. The driver device of claim 16, wherein the outer layer is made of rubber, such as neoprene or silicone.

18. The driver device of claim 17, wherein the outer layer comprises gripping sections that engage the nut and make it easier for the drill to rotate the nut on the threaded rod.

19. The driver device of claim 18, wherein the cylindrical center section comprises gripping sections that engage the nut.

20. A method of threading a threaded nut onto a threaded rod with ease, the method comprising the following steps:
providing a driver device comprising a body component that is cylindrical in shape with a blind cavity at one end and a rounded opposing end with chamfered edges;
inserting the blind cavity onto the square connector end of a driver bit;
securing the driver bit into the chuck of a cordless drill;
positioning the rounded end of the device in contact with a side of the threaded nut; and
engaging the drill which rotates the device and threads the nut onto the threaded rod.
